(19) United States
(12) Patent Application Publication
(10) Pub. No.: US 2025/0130688 A1
(43) Pub. Date: Apr. 24, 2025

(54) SMART HOME SYSTEMS AND METHODS FOR RECOMMENDING HOME IMPROVEMENTS

(71) Applicant: State Farm Mutual Automobile Insurance Company, Bloomington, IL (US)

(72) Inventors: Phillip Michael Wilkowski, Gilbert, AZ (US); Arsh Singh, Frisco, TX (US); Anish Agarwal, Chandler, AZ (US)

(21) Appl. No.: 18/664,037

(22) Filed: May 14, 2024

Related U.S. Application Data
(60) Provisional application No. 63/592,777, filed on Oct. 24, 2023.

(51) Int. Cl. G06F 3/0482; G06F 9/451

(52) U.S. Cl. CPC G06F 3/0482; G06F 9/451

(57) ABSTRACT

A computer system configured to recommend home projects while also identifying a homeowner's level of expertise for implementing the projects. The system may be configured to: (i) cause display of a first interface view of a frontend application to receive inputs for generating profiles of a home and the homeowner; (ii) determine a homeowner-personality type and a current level of the homeowner-personality type using the received inputs, including available features or functionalities at the home, and home improvement projects; (iii) generate a list of actions for the homeowner to take to move to a higher level for the determined homeowner-personality type; and/or (iv) cause display of a second interface view displaying the determined homeowner-personality type, the current level of the homeowner-personality type, and the list of actions to move to the higher level for determined homeowner-personality type.

### CROSS-REFERENCE TO RELATED APPLICATIONS

This application claims priority to U.S. Provisional Patent Application No. 63/592,777, filed Oct. 24, 2023, entitled “SMART HOME SYSTEMS AND METHODS FOR RECOMMENDING HOME IMPROVEMENTS,” the entire content of which is hereby incorporated herein by reference in its entirety.

### FIELD OF THE DISCLOSURE

The present disclosure generally relates to a smart home recommender for home improvements, and, more particularly, to a smart home network-based system and method for recommending home projects to increase safety and value in the home while also identifying a homeowner's level of expertise for implementing the projects.

### BACKGROUND

Currently when a homeowner wants to improve safety and/or a value of his/her home, there is no system available that intelligently identifies additions and/or improvements to a home of a homeowner that will increase safety and/or a value of the home while also identifying a skill level of the homeowner for implementing such additions and/or improvements. Each homeowner may have a different level of interest and skill in handling various home improvement projects, and/or different areas in which he/she may like to improve their home. In many cases, a homeowner may not even know where to start to improve the safety or value of their home, particularly in view of their ability to help implement such improvements.

Accordingly, there exists a need for an intelligent system and/or method that may help a homeowner to identify what home improvements are more likely to increase the safety and/or a value for a home that is also based on the identified homeowner-personality type and skill level. Conventional techniques may have additional drawbacks, ineffectiveness, inefficiencies, and encumbrances, as well.

### BRIEF SUMMARY

The present embodiments may relate to, inter alia, a system, method and/or a user application (e.g., a frontend application) in communication with a backend application (e.g., a backend application) for intelligently identifying a homeowner-personality type and/or details about the homeowner's home for recommending home improvement projects that would increase safety and/or a value of the home. The home improvement project is recommended using artificial intelligence (AI) and/or machine learning (ML) techniques in accordance with the homeowner's interests and/or choices for various home improvement areas in accordance with the homeowner-personality type.

In one aspect, a computer system may be configured to recommend home improvements and/or increasing the safety and/or value of a home. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computer system having at least one memory and at least one processor in communication with the at least one memory may be provided. The at least one processor may be configured to perform operations comprising: (i) causing display of a first interface view of a frontend application executing on a user equipment of a homeowner to receive inputs corresponding to generating a profile of a home of the homeowner and a profile of the homeowner; (ii) receiving inputs corresponding to at least one of available features or functionalities at the home; (iii) receiving inputs corresponding to information associated with one or more home improvement projects; (iv) determining a homeowner-personality type and a current level of the homeowner-personality type using at least some of the received inputs including the at least one of available features or functionalities at the home, and the one or more home improvement projects; (v) generating a list of actions for the homeowner to take to move to one or more higher levels for the determined homeowner-personality type; and/or (vi) causing display of a second interface view of the frontend application for displaying at least one of the determined homeowner-personality type, the current level of the homeowner-personality type, and/or the list of actions to move to the one or more higher levels for determined homeowner-personality type. The system may include additional, less, or alternate functionality, including that discussed elsewhere herein.

In another aspect, a computer-based or computer-implemented method for recommending home improvements and/or increasing the safety and/or value of a home may be provided. The method may be implemented via one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, a computer-implemented method may include: (i) causing display of a first interface view of a frontend application executing on a user equipment of a homeowner to receive inputs corresponding to generating a profile of a home of the homeowner and a profile of the homeowner; (ii) receiving inputs corresponding to at least one of available features or functionalities at the home; (iii) receiving inputs corresponding to information associated with one or more home improvement projects; (iv) determining a homeowner-personality type and a current level of the homeowner-personality type using at least some of the received inputs including the at least one of available features or functionalities at the home, and the one or more home improvement projects; (v) generating a list of actions for the homeowner to take to move to one or more higher levels for the determined homeowner-personality type; and/or (vi) causing display of a second interface view of the frontend application for displaying at least one of the determined homeowner-personality type, the current level of the homeowner-personality type, and the list of actions to move to the one or more higher levels for determined homeowner-personality type. The method may include additional, less, or alternate steps including that discussed elsewhere herein.

In yet another aspect, a non-transitory computer-readable storage media having computer-executable instructions embodied thereon is disclosed. The computer-executable instructions when executed by at least one processor, the computer-executable instructions cause the at least one processor to: (i) cause display of a first interface view of a frontend application executing on a user equipment of a homeowner to receive inputs corresponding to generating a profile of a home of the homeowner and a profile of the homeowner; (ii) receive inputs corresponding to at least one of available features or functionalities at the home; (iii) receive inputs corresponding to information associated with one or more home improvement projects; (iv) determine a homeowner-personality type and a current level of the homeowner-personality type using at least some of the received inputs including the at least one of available features or functionalities at the home, and the one or more home improvement projects; (v) generate a list of actions for the homeowner to take to move to one or more higher levels for the determined homeowner-personality type; and/or (vi) cause display of a second interface view of the frontend application for displaying at least one of the determined homeowner-personality type, the current level of the homeowner-personality type, and the list of actions to move to the one or more higher levels for determined homeowner-personality type. The computer executable instructions may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 depicts an exemplary configuration of a smart system for determining a homeowner-personality type and recommending upgrades to a home of the homeowner to increase safety and/or a value of the home, in accordance with one embodiment of the present disclosure.

FIG. 2 depicts an exemplary configuration of a user device or user equipment for use with the system of FIG. 1, in accordance with one embodiment of the present disclosure.

FIG. 3 depicts an exemplary configuration of an application server for use with the system of FIG. 1, in accordance with one embodiment of the present disclosure.

FIG. 4 depicts an exemplary chart that shows how to unlock rewards and/or upgrade to a next level, in accordance with one embodiment of the present disclosure.

FIG. 5 depicts an exemplary view of a frontend application executing on the user device or user equipment shown in FIG. 2 for adding currently available features and/or functionalities at a homeowner's home, in accordance with one embodiment of the present disclosure.

FIG. 6 depicts an exemplary view of a frontend application executing on the user device or user equipment shown in FIG. 2 for displaying notifications and/or alerts, in accordance with one embodiment of the present disclosure.

FIG. 7 depicts an exemplary view of a frontend application executing on the user device or user equipment shown in FIG. 2 for displaying different homeowner-personality types and respective factors for each homeowner-personality type, in accordance with one embodiment of the present disclosure.

FIG. 8 depicts exemplary views of a frontend application executing on the user device or user equipment shown in FIG. 2 for showing various upgrades and inventories available for a particular homeowner-personality type, in accordance with one embodiment of the present disclosure.

FIG. 9 depicts a process flow of exemplary computer-implemented method operations for determining a homeowner-personality type and recommending upgrades to a homeowner that is more likely to increase safety and/or a value of a homeowner's home, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

Various embodiments in the present disclosure may relate to, inter alia, an intelligent system and/or method for identifying a homeowner-personality type and suggesting or recommending home improvements in accordance with the identified homeowner-personality type. By way of an example, the homeowner-personality type may be identified based on a survey taken by the homeowner using a frontend application that is communicatively coupled with a backend application. The frontend application may be executing on a user computing device of the homeowner and the backend application may be executing on one or more application servers, as described in more detail below.

In some embodiments, based upon the homeowner's answers to survey questions, the homeowner-personality type including for example, but not limited to, a DIYer personality, a technical personality, a protector personality, a designer personality, an activist personality, a home safety enthusiast personality, and/or an investor personality, and so on, may be identified. A particular homeowner-personality type may be determined based upon the homeowner's answers to questions in various categories such as, questions regarding the homeowner's property, the homeowner's biographic and/or demographic information, past home improvement projects and/or ways in which each of the past home improvement projects were implemented by the homeowner, future home improvement projects, and/or a budget allocated for one or more past and/or future home improvement projects, and so on.

In addition, the answers to the survey questions, a homeowner's personality type may also be determined based on sensor data acquired from the home or the homeowner's computing device. This sensor data may be provided to the backend computing device that is configured to analyze such sensor data and based on that data determine a homeowner's personality type.

By way of a non-limiting example. the DIYer personality type may be determined based on how a homeowner maintains his/her home, a number of repairs and/or upgrades performed and how each repair and/or upgrade was performed. The technical personality type may be determined based on technical gadgets installed at the homeowner's home, technical security equipment, Wi-Fi speed at the homeowner's home, and so on. Some of this data may be collected by smart sensors that are associated with or located at the home. The protector personality type (or the home safety enthusiast personality type) may be determined based on the homeowner's answers corresponding to initiatives taken to protect or increase safety at the home. The designer personality type may be determined based on the homeowner's initiatives for remodeling the home (e.g., for lighting and/or appliances, and so on). The activist personality type may be determined based on the homeowner's interest and initiatives, for example, for reducing the homeowner's carbon footprint, and/or preserving or avoiding wastage of natural resources, and so on. The investor type may be determined based on actions taken by the homeowner for strategic upgrades at low cost that increases a value of the home or provides a better return of the investment.

By way of a non-limiting example, a budget allocated by the homeowner for various home improvement tasks or projects including, but not limited to, clean air vents, deep clean clogged pipes, resealing fences and/or decks, a smart thermostat, a smart home hub, smart light switches and/or bulbs, theft deterrent systems (e.g., cameras, motion detectors/sensors, motion-activated lights, and so on), an interior/exterior redesigning/decoration, energy sources, energy usages, upgrades to the home, and so on, may also be collected as an input into the system.

The homeowner-personality type identified for a homeowner may be a mix of more than one homeowner-personality. For example, a homeowner may be identified, based upon the homeowner's answers to survey questions, having an activist personality and an investor personality based on the homeowner's inclination to use more environmentally friendly appliances and upgrading properly working appliances. The homeowner may select an avatar from a set of available avatars. The set of available avatars may correspond with the homeowner-personality type. The selected avatar may be displayed in the frontend application executing on the homeowner's user equipment. When the homeowner's home is displayed in another homeowner's frontend application, the homeowner's selected avatar may be displayed as associated with the homeowner's home. The homeowner may also create an avatar and associate it with the homeowner's home and/or the homeowner-personality type.

In some embodiments, details regarding the homeowner's property, for example, various features and/or functionalities may be collected from the homeowner using a list or a set of known features and/or functionalities being displayed to the homeowner, and the homeowner selecting one or more features and/or functionalities available at the home. Getting details of the homeowner's property in this way may make it easier for the homeowner to provide details of his/her home without forgetting a feature and/or a functionality.

Additionally, or alternatively, bow each feature and/or functionality from the set of known features and/or functionalities may impact a value and/or safety of the homeowner's home may also be displayed when the homeowner clicks, selects, and/or brings a cursor within a predetermined threshold distance of a graphical element corresponding to the feature and/or functionality displayed in the frontend application. Additionally, or alternatively, based upon the current features and/or functionality available at the homeowner's home, which new features and/or functionalities may be added in order to increase safety and/or a value of the home may be suggested or recommended to the homeowner.

Also, new updates, new products, and/or any product recalls corresponding to one or more features and/or functionalities currently present at the homeowner's home may be pushed to the frontend application and/or pulled by the homeowner for displaying in the frontend application. In some examples, the homeowner's budget input that may be allocated for one or more future home improvement projects may be considered in suggesting or recommending which new feature and/or functionality may be added to the homeowner's home. Since the recommendation and/or suggestion is based upon the known features and/or functionalities available at the homeowner's home, a new update and/or a new product suggested to the homeowner may avoid any duplication.

Additionally, or alternatively, while determining a homeowner-personality type for a homeowner, survey answers by one or more other homeowners in the same neighborhood as the homeowner's home and/or in a different neighborhood may also be considered. The system assigned personality type of the homeowner or survey taker may be shown to the homeowner. Additionally, or alternatively, how many other homeowners (in the same demographic area or different demographic areas) that are assigned the same homeowner-personality type may also be displayed in the frontend application. Other homes in the same neighborhood as the homeowner and/or located in other neighborhoods that include similar features and/or functionalities may also be displayed in the frontend application to motivate the homeowner to upgrade their home in accordance with the homeowner's lifestyle, budget, and/or liking. In particular, the homeowner-personality type, which is identified by the system for the homeowner, may help the system and the homeowner to better understand which of the features and/or functionalities should be included or added in the home of the homeowner.

In some embodiments, the system is configured to determine a current level of the homeowner for the homeowner-personality type that may be assigned to the homeowner. The current level being an indicator of how strongly the homeowner fits or matches the criteria stored withing memory for that particular homeowner-personality type. For example, if the system determines that the homeowner has homeowner-personality type of an activist personality type, then depending on current expenditure and/or steps taken by the homeowner, and/or appliances installed by the homeowner within their home (or other data inputs), the current level of the homeowner for the homeowner-personality type may be determined by the system. By way of a non-limiting example, a homeowner who uses only LED bulbs in the home may be identified at level-1 activist personality type, while another homeowner who uses solar panels to generate all required electricity for his/her home may be identifier at a higher level than level-1. Thus, the system is configured to utilize this data along with AI and ML techniques to determine both the personality type and the level at which the homeowner is associated with that personality type.

Accordingly, as the homeowner upgrades and/or adds new features or functionalities to their home, the current level of the homeowner within the homeowner-personality type may also be updated and/or upgraded. In some examples, the homeowner may be provided one or more rewards for upgrading his/her level for the corresponding homeowner-personality type. By way of a non-limiting example, a reward may include a discount on the purchase of an appliance and/or a service required to upgrade the home which may bring the homeowner to the next level of the homeowner-personality type. In some examples, the reward may be a certificate and/or additional discount on the home insurance policy, and so on.

In some examples, a chart (displayable on a user interface) may be generated by the system showing the homeowner's current level for the particular homeowner-personality type and a homeowner action (or actions) that may be taken by the homeowner to raise the homeowner level to the next level. In some examples, if the homeowner actions correspond with purchasing of an item, the homeowner may be displayed one or more stores where the item may be purchased. The one or more stores where the item may be purchased may be displayed based on a location of the homeowner's home and/or the homeowner's user equipment, a minimum price and/or a maximum price, and/or other criteria, which may be selected by the backend application and/or may be provided as input by the homeowner.

In some examples, a current level for a homeowner-personality type for one or more other homeowners may be displayed to the homeowner in accordance with privacy settings selected by the one or more other homeowners. Additionally, or alternatively, how the homeowner's home compares with respect to other homeowner's home may be identified and displayed to the homeowner in the frontend application executing on the user equipment of the homeowner. A ranking score may be calculated or generated for the homeowner's home based on the available features and/or functionality for the homeowner's home. The ranking score may be used to show the homeowner's home in comparison with other homes in the same neighborhood or a different neighborhood.

In some embodiments, the homeowner may be sent notifications and/or alerts in the frontend application, and/or an email or a text message to alert the homeowner about maintenance tasks requiring the homeowner's attention and/or to maintain the home's value or prevent a ranking score of the home from going down. The ranking score may indicate features and/or functionalities available at the homeowner's home in comparison with features and/or functionalities available at other homes in the same neighborhood or other neighborhoods.

For example, if the roof on a homeowner's home is approaching its lifetime of use, the system may automatically generate an alert and may then send the alert to the homeowner advising the homeowner to have the roof inspected and/or replaced. Upon having the roof inspected and/or replaced, the homeowner may specify within the system that the task has been completed (e.g., the roof has been replaced, or the roof has been inspected, and so on). By updating the system either manually or via home sensor data received from the home sensors, the value of the home or the ranking score of the home will be automatically adjusted by the system using the new roof data to increase the value of the home or upwardly adjust the safety ranking of the home. By way of a non-limiting example, the notifications and/or alerts may be of more than one different category such as an emergency category, a warning category, and/or a watch category. Further, how a notification and/or an alert for each category may be delivered or displayed to the homeowner may be configurable. The homeowner may receive a notification and/or an alert for the emergency category in the frontend application, and/or as an email or a text message, but for the warning category and/or the watch category in the frontend application only.

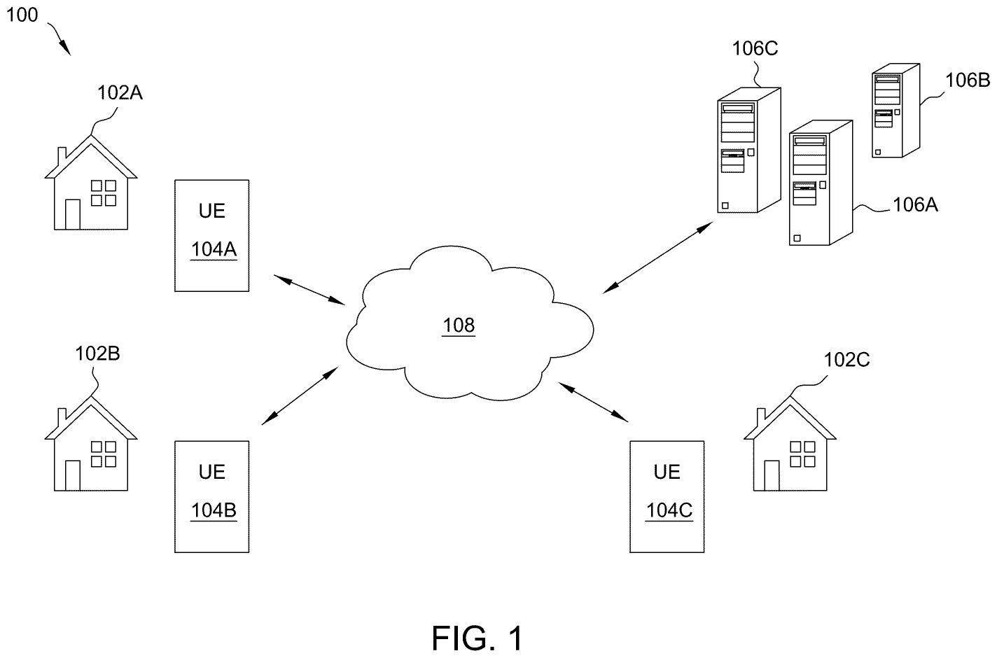

The various embodiments in the present disclosure thus provide a system and/or an application, which may help a homeowner to identify what home improvement may be more likely to increase safety and/or a value for his/her home that is based on the identified homeowner-personality type and a home profile that is based on the currently available features and/or functionality in the home. The homeowner's homeowner-personality type and how the homeowner and his/her home compare with other homeowners and other homes may motivate the homeowner to increase his/her interest to maintain or upgrade value or safety of his/her home. These embodiments are described herein using FIG. 1-FIG. 9 below.

### EXEMPLARY TELEMATICS SYSTEM

FIG. 1 depicts an exemplary configuration of a smart computing system 100 that may help a homeowner to identify what home improvement(s) may be more likely to increase safety and/or a value of the homeowner's home. The system 100 may recommend or suggest home improvement project(s) based upon the identifying of a homeowner-personality type of the homeowner and a home profile. The home profile may be generated or determined based upon the currently available features and/or functionalities in the home. As shown in FIG. 1, homeowners' homes 102A, 102B, and/or 102C may communicate with one or more application servers 106A, 106B, and/or 106C using user devices or user equipments (UEs) 104A, 104B, and/or 104C, respectively, via a network 108.

By way of a non-limiting example, a user equipment 104A, 104B, and/or 104C may be a mobile device, smart watch, smart contact lenses, augmented reality (AR) glasses, virtual reality (VR) headset, mixed or extended reality headset or glasses, wearables, voice or chat bot, ChatGPT or ChatGPT-based bot, an Internet-of-Thing (IoT) device, other input device, and/or other electronic or electrical devices. The network 108 may be a Wi-Fi network, a local area network (LAN), a wide area network (WAN), a WiMax network, a 3G network, a 4G network, a 5G network, a 6G network, an Internet, and/or a satellite network, and so on. The one or more application servers 106A, 106B, and/or 106C may be hardware and/or a virtual machine instance, which may be collocated or geographically distributed. The one or more application serves 106A, 106B, and/or 106C may be deployed in a cloud computing network or deployed in a hosting environment of an organization providing functionalities and/or services, as described herein, according to one or more exemplary embodiments.

A user application (e.g., a frontend application, not shown in FIG. 1) executing on the UE (also referred to as user computing device), for example, UE 104A, 104B, and/or 104C, may be a mobile application, a web browser application and/or a native application, and may be referenced herein as a frontend application. A backend application executing on the one or more servers 106A, 106B, and/or 106C may be a monolithic application or microservices deployed in the one or more servers 106A, 106B, and/or 106C.

A homeowner may provide inputs, using the frontend application, to create a homeowner profile. The homeowner may provide answers to automatically generated survey questions for determining a homeowner-personality type of the homeowner. The survey questions may be automatically generated by the backend application. The survey questions may include questions regarding the homeowner's home and various features or functionalities, and/or appliances, and so on. The survey questions may also include the homeowner's biographic and/or demographic information, past home improvement projects and/or ways in each of the past home improvement projects was implemented, future home improvement projects, and/or a budget allocated for one or more past and/or future home improvement projects, and so on. In other embodiments, sensor data may be collected from the home (via sensor within the home or a smart home or through a user computing device associated with the home) and used to determine what personality type is assigned to the homeowner.

Corresponding to the identified homeowner-personality type, the backend application may display or generate recommendations for one or more home improvement projects for displaying in the frontend application. The one or more home improvement projects recommended to the homeowner may increase a value and/or safety of the homeowner's home. The homeowner may provide further updates, for example, using the frontend application, to the backend application, when the suggested home improvement project is initiated and/or completed. Based upon the updates from the homeowner, a level associated with the homeowner's homeowner-personality type may be updated. Additionally, or alternatively, the homeowner's homeowner-personality type may be updated based upon actions or initiatives taken by the homeowner, for example, including but not limited to, taking some learning lessons, or watching videos, upgrading, or adding one or more features or functionalities to the homeowner's home, and so on. In some examples, when the homeowner moves to a higher level in the respective homeowner-personality type, the backend application may automatically generate a reward for the homeowner consistent with the homeowner's respective homeowner-personality type, as described in the present disclosure.

The frontend application executing on the UEs 104A, 104B, and/or 104C and the backend application executing on the one or more servers 106A, 106B, and/or 106C may communicate data including one or more images, one or more video data files, text, and/or voice, and so on, as a webservice message over a hypertext transfer protocol (http) or a hypertext transfer protocol secure (https) protocol. The webservice message may be according to a Representational State Transfer (REST) application programming interface (API), a Simple Object Access Protocol (SOAP) API, a graph query language (GraphQL) API, a webhook API, and/or remote procedure call (RPC), and so on. The data may be communicated as (i) an extended markup language (XML), (ii) a JavaScript Object Notation (JSON), (iii) a Concise Binary Object Representation (CBOR), (iv) hypertext markup language (html), (v) a binary JSON (BSON), (vi) protocol buffers, and (vii) so on.

In some embodiments, the homeowners' homes 102A, 102B, and/or 102C, may be equipped with a network of one or more sensors that collect health data of the homeowner's home including various types of data that may impact home health or may reflect risks to the house, such as from acts of nature (e.g., weather, seismic activity, flooding, or the like) or from man-made risks or other inherent risks to a home (e.g., electrical fires from aging wiring, theft or vandalism of property, aging appliances or heating, ventilation and air conditioning (HVAC), or the like), or other home data that may positively or negatively impact risks to and insurability of the home. The network of one or more sensors may also collect data about different attributes of the home, such as, but not limited to, power usage, water usage, current temperatures, doors and/or windows open or closed, as well as current and future weather conditions and other parameters that may affect the home.

In some embodiments, and by way of a non-limiting example, the network of one or more sensors may include, but not limited to, electricity monitoring (“EM”) devices to monitor electricity flowing to individual electric devices, such as smart devices or appliances, electronics, vehicles, or mobile devices, and may be configured to monitor or detect abnormal usage or trends. Abnormal electricity flow (“EF”) to various devices may indicate that failure is imminent, maintenance or device replacement is needed, de-energization is recommended, or other corrective actions are prudent. In some examples, the EM devices may be TING® smart sensors such as those made commercially available by Whisker Labs of Germantown, MD.

EF data collected by the EM devices may include data indicative of electricity flow to or from various smart or other electronic devices. EF data may also include electricity or energy usage for each electronic component, device, outlet, circuit, or the like, within the home, such as data indicating the electricity each device or room is using. For example, energy usage of air conditioners, washers, dryers, dish washers, refrigerators, stoves, ovens, microwave ovens, televisions, lamps, outlets, computers, laptops, mobile devices, other electronic devices, may be determined by the EM device. EF data may be used to detect hazards or other abnormalities that may indicate a risk to the home or its assets.

In some embodiments, and by way of a non-limiting example, data about the homeowner's home may be collected from external sources (e.g., publicly available data, such as historical weather-related information or power outage statistics for the area, emergency service response statistics for the area, or the like) or from home sources (e.g., data gathered from sensors, appliances, or networked devices within and/or around the house). The homeowner/user may also provide, using the frontend application, inputs corresponding to data from different monitors and other devices in the home, such as Internet of Things (IoT) devices. The IoT devices may provide their data directly, and/or provide data through servers associated with and in communication with the IoT devices.

In some embodiments, the smart system 100 may analyze the data received by the backend application using an artificial intelligence based model and/or a machine-learning model. The AI-based model and/or the ML model may analyze data of the homeowner's home along with data of other homes in the neighborhood and/or data of other homes in the nearby neighborhood. Based upon the analysis of data, using the AI-based model and/or the ML model, the homeowner's home may be ranked or a ranking score of the homeowner's home in comparison with other homes in the same and/or different neighborhood may be determined. Similarly, the AI-based model and/or the ML model may analyze the homeowner's skills in comparison with skills of other homeowners.

By way of a non-limiting example, the AI-based model and/or the ML model may analyze data received from electrical circuit sensors in the homeowner's home corresponding to detecting various inconsistencies or symptoms of dangerous conditions, such as arcing caused by faulty or separating connections on the circuit. Such arcing conditions can lead to greater resistance and heat generated over time, which may eventually lead to a fire within the house. Such data may be periodically received and analyzed by the AI-based model and/or the ML model, and based upon the analysis, evaluations of potential risks to the homeowner (e.g., articulating the source and nature of the risk within the home) may be determined and presented to the homeowner in the frontend application. The AI-based model and/or the ML model may recommend one or more home improvement projects to the homeowner for risk mitigation (e.g., detailing how the identified risks may be reduced), or alerting for contemporaneous events detected within the home (e.g., transmitting an alert to a mobile device or nest device of the homeowner upon detection of fire, power outage, nearby lightning strike, network outage). In some embodiments, the one or more home improvement project recommendations may identify areas of improvement or risk reduction that may impact safety or insurability of the home, and/or increase ranking score of the homeowner's home in comparison with other homes.

The AI-based model and/or the ML model may be trained using a subset of the data received from a plurality of homeowners and/or a network of one or more sensors. The trained AI-based model and/or the ML model may be validated using another subset of the data received from the plurality of homeowners and/or the network of one or more sensors prior to deployment. The AI-based model and/or the ML model may be periodically updated or re-trained using the data received from the plurality of homeowners and/or the network of one or more sensors prior to deployment.

### EXEMPLARY COMPUTING DEVICE

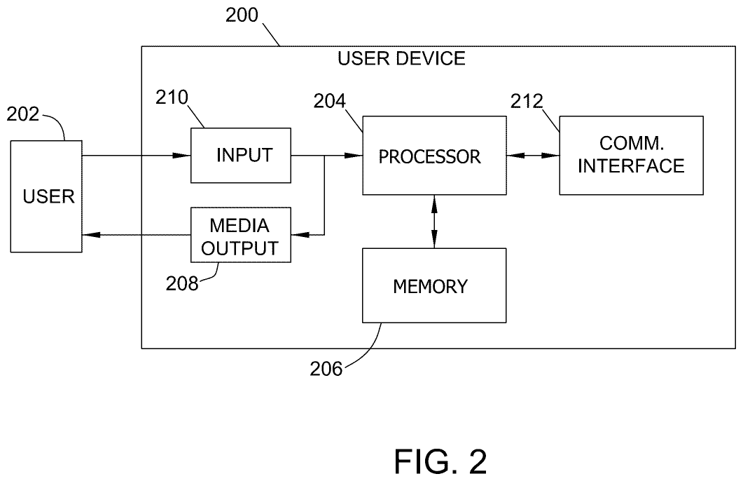

FIG. 2 depicts an exemplary configuration of a user device 200, in accordance with one embodiment of the present disclosure. The user device 200 may be similar to the user equipment 104A, 104B, and/or 104C and operated by a user or a homeowner of a home, such as he home 102A, 102B, and/or 102C. User device 200 may include, but is not limited to, a smart phone, a tablet, a laptop, an electronic device equipped with at least one transceiver to communicate with one or more servers 106A, 106B, and/or 106C. Additionally, or alternatively, the user device 200 may be, for example, a mobile device, smart home controller, a smart watch, smart contact lenses, augmented reality (AR) glasses, virtual reality (VR) headset, mixed or extended reality headset or glasses, wearables, voice or chat bot, other input device, and/or other electronic or electrical devices.

The user device 200 may include a processor 204 for executing instructions. In some embodiments, executable instructions may be stored in a memory 206. Processor 204 may include one or more processing units (e.g., in a multi-core configuration). Memory 206 may be any device allowing information such as executable instructions and/or transaction data to be stored and retrieved. Memory 206 may include one or more computer readable media.

The user device 200 may also include at least one media output component 208 for presenting information to user 202. Media output component 208 may be any component capable of conveying information to user 202. In some embodiments, media output component 208 may include an output adapter (not shown) such as a video adapter and/or an audio adapter. An output adapter may be operatively coupled to processor 204 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 208 may be configured to present a graphical user interface (e.g., a web browser and/or a client application) to user or a homeowner 202. A graphical user interface may include, for example, an interface for viewing prompts and data. In some embodiments, the user device 200 may include an input 210 for receiving input from user 202. User 202 may use input 210 to, without limitation, provide user input.

Input device 210 may include, for example, a keyboard, a pointing device, a mouse, a stylus, a touch sensitive panel (e.g., a touch pad or a touch screen), a gyroscope, an accelerometer, a position detector, a biometric input device, at least one vision sensor (e.g., a camera or a video camera), and/or an audio input device. A single component such as a touch screen may function as both an output device of media output component 208 and input device 210.

The user device 200 may also include a communication interface 212, communicatively coupled to a backend system, an application server, and/or one or more servers (e.g., servers 106A, 106B, and/or 106C). Communication interface 212 may include, for example, a wired or wireless network adapter and/or a wireless data transceiver for use with the network 108.

Stored in memory 206 are, for example, computer readable instructions for providing a user interface to user 202 via media output component 208 and, optionally, receiving and processing input from input 210. A user interface may include, among other possibilities, a web browser and/or a client application. Web browsers enable users, such as user 202, to display and interact with media and other information typically embedded on a web page or a website from the backend system. A client application (e.g., a frontend application executing on the user device 200) may allow the user 202 to interact with, for example, the backend system.

In some embodiments, generative artificial intelligence (AI) models (also referred to as generative machine learning (ML) models) may be utilized with the present embodiments, and the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by and/or used in conjunction with reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

### EXEMPLARY APPLICATION SERVER

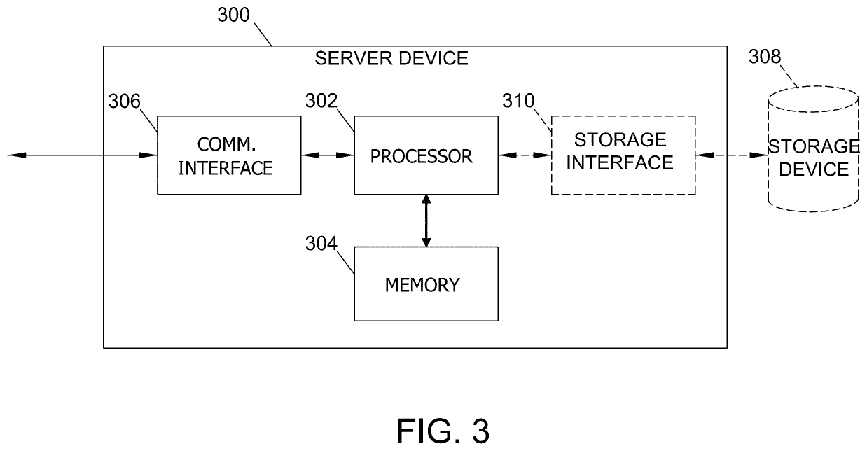

FIG. 3 depicts an exemplary configuration of an application server (or other application computing devices) 300 of a backend system, in accordance with one embodiment of the present disclosure. Application server 300 may be similar to the server 106A, 106B, and/or 106C, and may be configured to perform various operations, as described herein, from the backend system perspective. Processor 302 may include one or more processing units (e.g., in a multi-core configuration). Processor 302 may be operatively coupled to a communication interface 306 such that the application server 300 is capable of communicating with a remote device, such as another application server 300, the user equipment 104A, 104B, and/or 104C, for example, via the network 108 using wireless communication or data transmission over one or more radio links or digital communication channels. For example, communication interface 306 may receive data, e.g., image, video, text, and so on.

Processor 302 may also be operatively coupled to a storage device 308. Storage device 208 may be any computer-operated hardware suitable for storing and/or retrieving data, such as, but not limited to, data associated with historic databases. In some embodiments, storage device 308 may be integrated in the application server 300. For example, the application server 300 may include one or more hard disk drives as storage device 308.

In other embodiments, storage device 308 may be external to host computing device 300 and may be accessed by a plurality of host computing devices 300. For example, storage device 308 may include a storage area network (SAN), a network attached storage (NAS) system, and/or multiple storage units such as hard disks and/or solid-state disks in a redundant array of inexpensive disks (RAID) configuration.

In some embodiments, processor 302 may be operatively coupled to storage device 308 via a storage interface 310. Storage interface 310 may be any component capable of providing processor 302 with access to storage device 308. Storage interface 310 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 202 with access to storage device 208.

Processor 302 may execute computer-executable instructions for implementing aspects of the disclosure. In some embodiments, the processor 302 may be transformed into a special purpose microprocessor by executing computer-executable instructions or by otherwise being programmed. In some embodiments, and by way of a non-limiting example, the memory 304 may include instructions to perform specific operations, as described herein. The processor 303 may implement an AI-based model and/or a ML model according to various embodiments as described herein.

### EXEMPLARY LEVELS OF HOMEOWNER'S HOMEOWNER-PERSONALITY TYPE

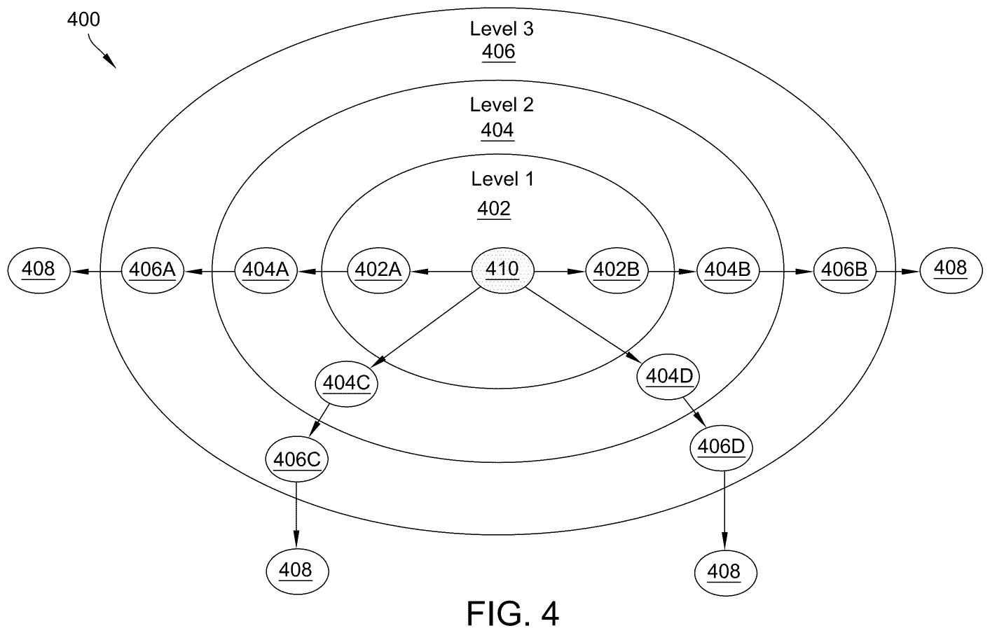

FIG. 4 depicts an exemplary chart 400 showing a homeowner-personality type 410. By way of a non-limiting example, the homeowner-personality type may be one of a DIYer personality, a technical personality, a protector personality, a designer personality. an activist personality, a home safety enthusiast personality, and/or an investor personality, and so on. There may be more than one level corresponding to a homeowner-personality type. In FIG. 4, three levels are shown: a level-1 402, a level-2 404, and a level-3 406. For each of level-1 402. level-2 404, and/or level-3 406, one or more actions and/or initiatives which the homeowner may take to move to a next level for the respective homeowner-personality type may be displayed.

By way of a non-limiting example, for a homeowner whose homeowner-personality type is a protector personality or a home safety enthusiast personality, setting a reminder for replacing a smoke alarm battery and replacing the smoke alarm battery, which is shown in FIG. 4 as 402A, and/or checking an age of a smoke alarm installed in the homeowner's home and replacing the smoke alarm if the smoke alarm is, for example, 10 or more years old, which is shown in FIG. 4 as 402B may help the homeowner to move to the level-2 404.

Similarly, in some examples, by testing the smoke alarm each month and updating when required (that is shown in FIG. 4 as 404A), by sharing this information with the backend system (that is shown in FIG. 4 as 404B), by installing front and back door deadbolt locks (that is shown in FIG. 4 as 404C), and/or by installing a motion sensor light in front of a garage (that is shown in FIG. 4 as 404D), the homeowner may move to the level-3 406 for the particular homeowner-personality type. By placing a fire extinguisher on one or more floors as shown by 406A, by installing deadbolt locks on one or more exterior doors as shown by 406B, by installing motion sensor light on one or more exterior facing walls as shown by 406C, and/or by installing carbon monoxide detector as shown by 406D, the homeowner may unlock a reward that is shown in FIG. 4 as 408. By way of a non-limiting example, the reward may be a discount of purchase of an item and/or a service, and/or a discount on insurance, and so on. Other types of reward(s) or incentives may also be provided to the homeowner to motivate the homeowner to take actions that would increase safety and/or a value of the home.

The homeowner-personality type and/or a level of the homeowner's respective homeowner-personality type may be determined based at least in part on inputs received from a plurality of homeowners including, but not limited to, training sessions attended by the homeowners, home improvement projects initiated and/or completed by the homeowners, particular areas identified by the homeowner where the homeowner would like to improve features and/or functionalities of the homeowner's home, etc. The computing system, using the AI-based model and/or the ML model, may analyze the inputs from the plurality of homeowners and determine a relative ranking score for the homeowner for various homeowner-personality types.

Based upon the relative ranking score of the homeowner for various homeowner-personality types, a level for the homeowner-personality type may be determined. For example, a ranking score of 0 to 33 may be level-1, a ranking score of 34-66 may be level-2, and a ranking score 67 to 100 may be level-3. A number of levels and corresponding ranking score ranges described herein are for example only, and different number of levels and corresponding ranking score ranges may be used.

In another embodiment, the AI model and/or ML model may place certain characteristics within a personality type cluster and may weight each characteristic as to whether it belongs at level-1 or level-2 or level-3 within the cluster. The system may then use input data for each homeowner to determine how each homeowner matches up to each cluster of personality types, and at what level based on the specific characteristics held by the homeowner and how they are weighted within the cluster. By so doing, the system can use the homeowner input to determine which personality type the homeowner is and at what level the homeowner is within that type.

### EXEMPLARY VIEW OF A FRONTEND APPLICATION FOR PROVIDING INFORMATION OF FEATURES AND/OR FUNCTIONALITY AT HOME

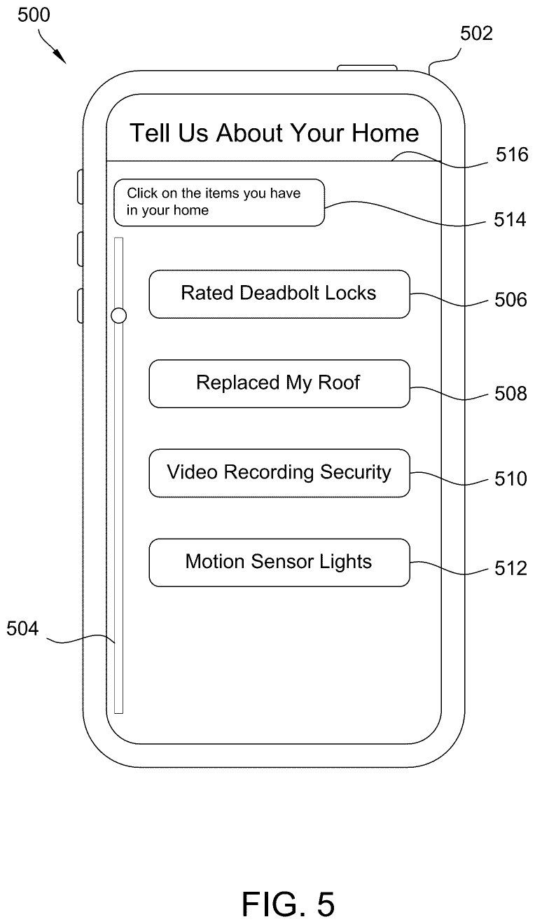

FIG. 5 depicts an exemplary view 500 of a frontend application executing on a UE 502, which may be as shown in FIG. 2. In particular, to create a home profile and to recommend or suggest any upgrade or update to a homeowner's home without suggesting the homeowner to upgrade or update that is already present, the homeowner may be asked to provide details of his/her home as shown by 516. Instead of the homeowner providing information about his/her home, a list of possible items, features, and/or functionalities may be displayed as graphical elements on a display of the UE 502. The user may select an item, a feature, and/or a functionality by clicking or selecting a graphical element, for example, rated deadbolt locks 506, replaced my roof 508, video recording security 510, and/or motion sensor lights 512, as shown in FIG. 5 as 514. The homeowner may view additional items, features, and/or functionality by using a scrolling bar 504. By bringing a cursor within a particular threshold distance of a graphical element corresponding to an item, a feature, and/or a functionality, details about that item, feature, and/or functionality including description and/or one or more images may be shown as an overlay over the current view to assist the homeowner to provide more accurate details of his/her home.

### EXEMPLARY VIEW OF A FRONTEND APPLICATION FOR DISPLAYING A NOTIFICATION AND/OR AN ALERT

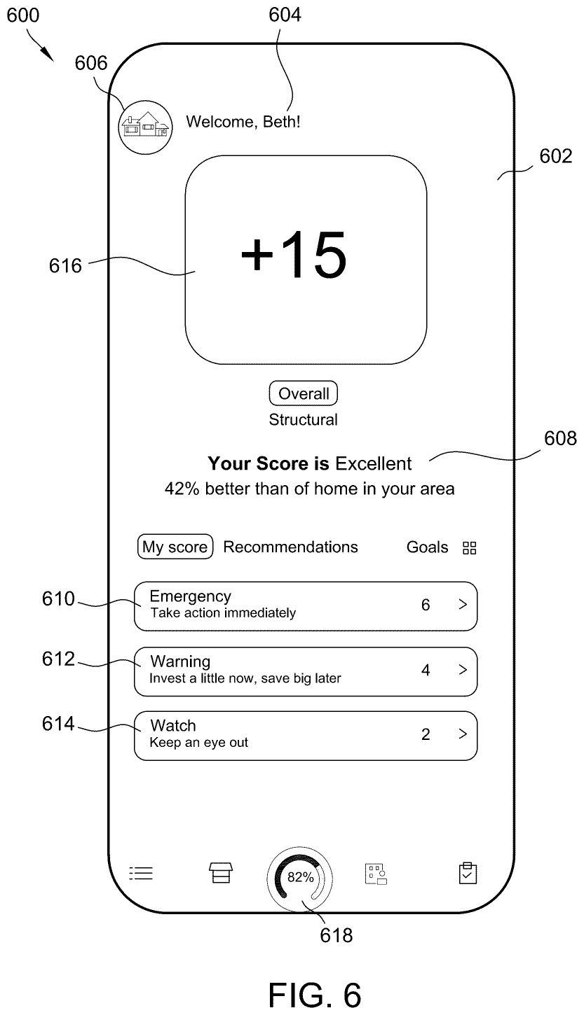

FIG. 6 depicts an exemplary view 600 of a frontend application on a display 602 of a UE 502, which may be as shown in FIG. 2. As shown in the view 600, a greeting to a homeowner 604 may be displayed along with an avatar, an image, and/or a profile picture 606 of the homeowner. By way of a non-limiting example, the avatar 606 may be automatically generated based on the identified homeowner-personality type of the homeowner. Additionally, or alternatively, the avatar, the image, and/or the profile picture 606 may be provided by the homeowner.

As shown in FIG. 6, a current ranking score 618 and/or a grade 608 (e.g., worst, worse, bad, okay, good, better, and/or excellent, and so on) may be displayed. The ranking score 618 and/or the grade 608 may be generated based comparing the homeowner's home with other homes in the same neighborhood and/or different neighborhoods. Additionally, or alternatively, a change in the ranking score may be displayed as shown in FIG. 6 by 616. By way of a non-limiting example, the change in the ranking score may be periodically or selectively calculated and displayed. The homeowner may be displayed one or more notifications and/or alerts based upon different severity levels (e.g., an emergency level 610, a warning level 612, and/or a watch level 614). The homeowner may configure to receive a notification and/or an alert as an email and/or a text message for one or more different severity levels.

### EXEMPLARY VIEW OF A FRONTEND APPLICATION FOR DISPLAYING VARIOUS HOMEOWNER-PERSONALITY TYPES

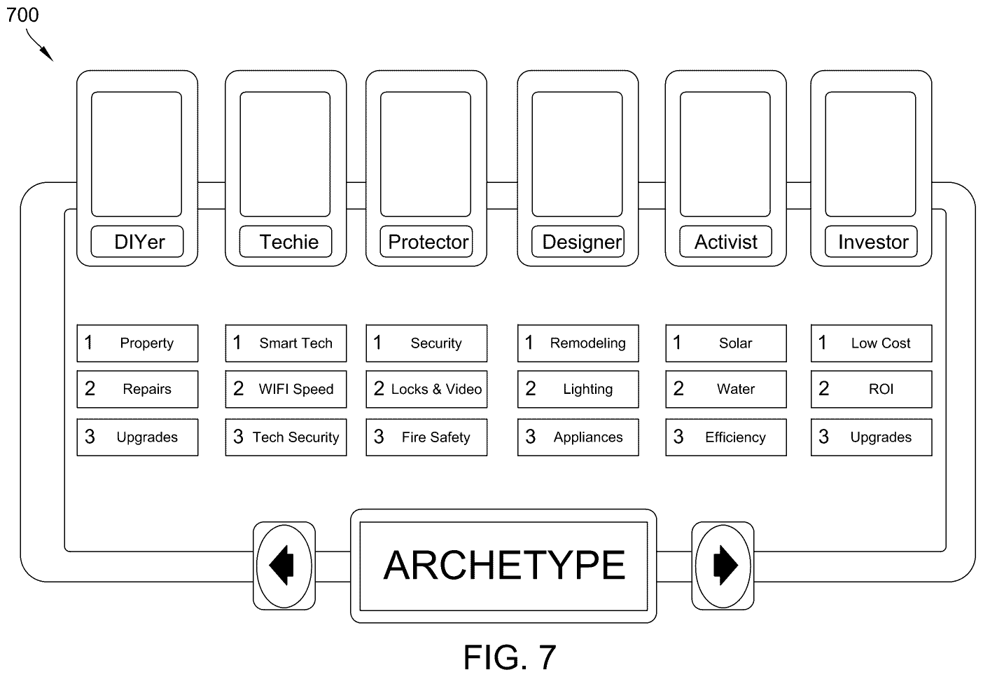

FIG. 7 depicts an exemplary view 700 of a frontend application showing different homeowner-personality types, for example, a DIYer personality, a technical personality, a protector personality, a designer personality. an activist personality, a home safety enthusiast personality, and/or an investor personality, and so on. An avatar corresponding to each homeowner-personality type may also be displayed. Additionally, or alternatively, a specific number of, for example, the top three, characteristics corresponding to each homeowner-personality type may be displayed. By way of a non-limiting example, the specific number of characteristics corresponding to each homeowner-personality type may be dynamically updated in part based upon how other homeowners are upgrading their homes, and/or the most common characteristics among homeowners of the particular homeowner-personality type.

In some embodiments, and by way of a non-limiting example, a homeowner may have more than one different homeowner-personality type, and an actual composition in percentage for each respective homeowner-personality type may be displayed in a card corresponding to each respective homeowner-personality type. For example, a homeowner may have 40% of a DIYer personality type, 30% of an activist personality type, and 30% of a protector personality type.

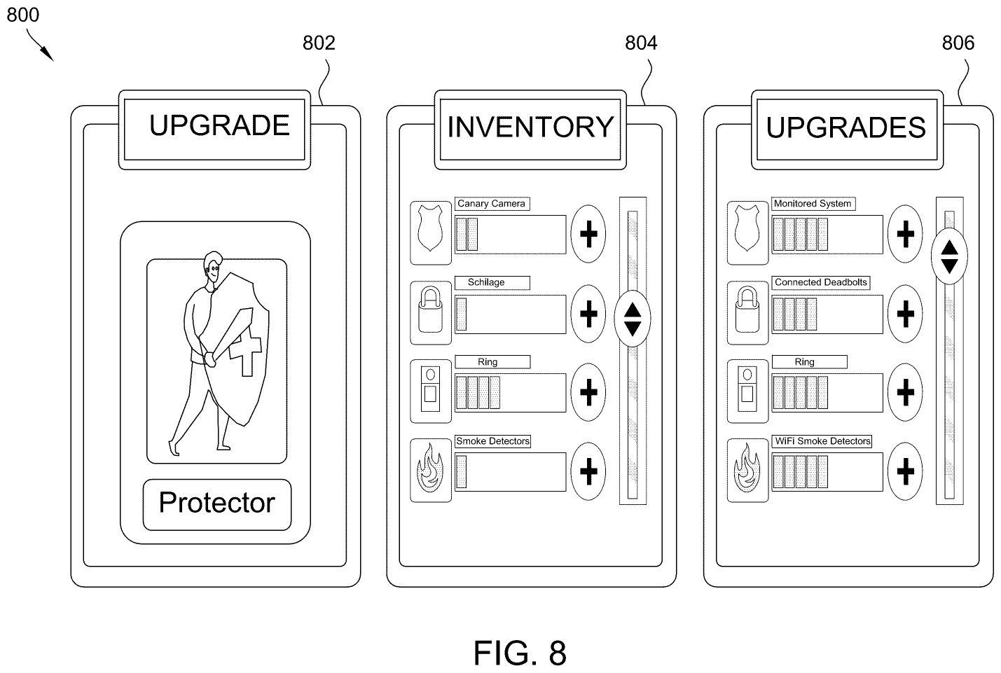

The homeowner may click on an avatar corresponding to a particular homeowner-personality type, for example, a protector personality type, and the homeowner may be displayed multiple cards or views as shown in FIG. 8 as 800. A card 802 showing a particular homeowner-personality type, a card 804 showing currently available features and/or functionalities associated with the particular homeowner-personality type, and/or a card 806 showing one or more available upgrades associated with the particular homeowner-personality type may be displayed.

### EXEMPLARY COMPUTER-IMPLEMENTED METHOD

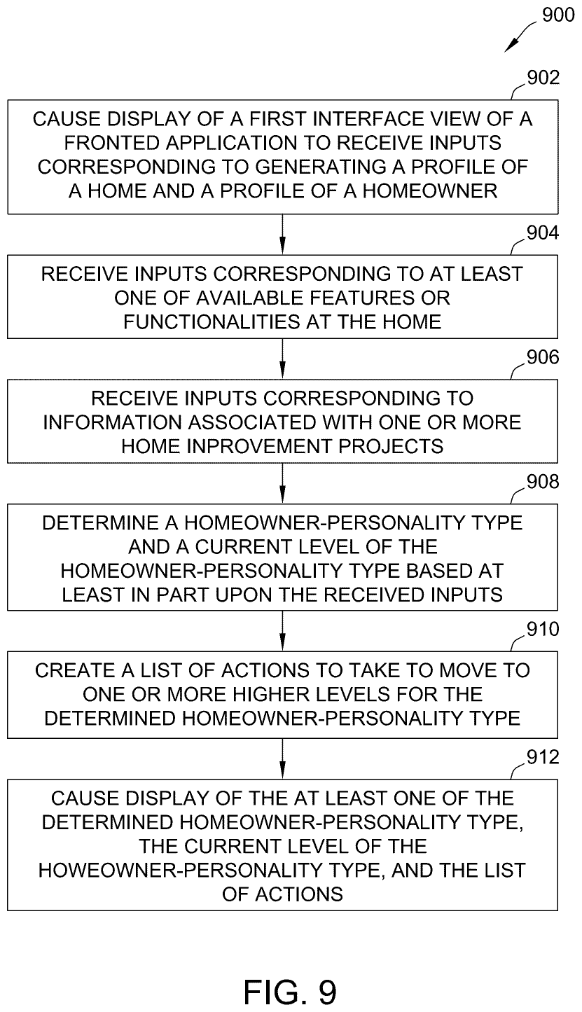

FIG. 9 depicts a process flow 900 of example computer-implemented method operations performed by at least one server of one or more servers (e.g., servers 106A, 106B, and/or 106C). A UE (e.g., a UE 104A, 104B, or 104C) may be communicatively coupled with the at least one server via the network 108, as described herein.

When a user of a UE launches an instance of a frontend application executing on the UE, an interface view of the frontend application may be displayed (902) on a display of the UE. The interface view may be referenced herein as a first interface view and may be displayed to collect user inputs for generating a profile of a home of a homeowner and/or a profile of the homeowner. The first interface view may include a plurality of graphical elements, and each graphical element may correspond with a particular feature or functionality that is currently available at the home of the homeowner and provide an affordance to select the particular feature or functionality. Based on the user's selection of one or more graphical elements of the plurality of displayed graphical elements, user inputs corresponding to at least one of available features or functionalities at the home may be received (904). By way of a non-limiting example, in some embodiments, upon detecting presence of a user input control (e.g., a mouse or touch-input) within a predetermined threshold distance of a graphical element, details corresponding to a feature, or a functionality associated with the graphical element may be displayed as an overlay over a current interface view of the frontend application.

In certain embodiments, graphical elements and/or overlays, and other visual or audible output (including the list of home improvement projects and personality types mentioned directly below), as well as user input, may be output (or input) via the user devices mentioned elsewhere herein. For instance, mobile devices, wearables, smart glasses, smart contacts, AR glasses, VR headsets, XR (extended reality) headsets, voice or chat bots, etc.

Additionally, or alternatively, the first interface view may also include a list of home improvement projects. By way of a non-limiting example, the list of home improvement projects may be generated at least in part based upon the currently available features or functionalities at the home of the homeowner. Accordingly, the list of home improvement projects may be dynamically updated in response to the received inputs from the user for generating the profile of the home. The list of home improvement projects may also include a flag or a checkbox corresponding to each project to indicate whether a project is a previously implemented project or a future project and/or a budget associated with the project. User inputs or information identifying at least a budget and/or whether the project is a future project or a previously implemented project may be received (906).

Based at least in part upon the received inputs corresponding the at least one of available features or functionalities at the home and based at least in part upon the received information associated with the one or more home improvement projects, a homeowner-personality type and a current level of the homeowner-personality type may be determined (908). By way of a non-limiting example, the homeowner-personality type and/or the current level of the homeowner-personality type may be identified based on the available features and/or functionalities at the home, previously completed and/or future home improvement projects, a budget allotted for each home improvement project, and so on. In some examples, other homes in the same neighborhood or different neighborhoods may be referenced to determine the homeowner-personality type and/or the current level of the homeowner-personality type.

Corresponding to the determined (908) homeowner-personality type and the determined (908) current level of the homeowner-personality type, a list of actions may be generated (910). The list of actions may include one or more actions that the homeowner may take to move to one or more higher levels for the determined homeowner-personality type. Accordingly, the list of actions may be different for different homeowners of the same homeowner-personality type since the list of actions is generated based upon the available features or functionalities at the home and/or the one or more (previous and/or future) home improvement projects. By way of a non-limiting example, a particular level of homeowner-personality type may be associated with an action included in the list of actions such that the user may be informed which action may be of more importance if the homeowner desires to move to a higher level for the homeowner-personality type.

At least one of the determined homeowner-personality type, the current level of the homeowner-personality type, and the list of actions to move to the one or more higher levels for determined homeowner-personality type may be displayed (912) in an interface view of the frontend application, which may be referenced herein as a second interface view. Additionally, or alternatively, a grade or a ranking score associated with the home of the homeowner may be determined and displayed. In some examples, a change in the grade or the ranking score associated with the home of the homeowner may be determined and displayed. The change in the grade or the ranking score may be determined periodically (e.g., every week, or every month), or aperiodically upon an event (e.g., an upgrade to the home or a performed maintenance of the home).

### ADDITIONAL EXEMPLARY EMBODIMENTS

In an exemplary embodiment, a computer system is provided. The computer system includes at least one memory; and at least one processor in communication with the at least one memory. The at least one processor is programmed to: cause display of a first interface view of a frontend application executing on a user device of a homeowner to receive inputs for generating a profile of a home of the homeowner and a profile of the homeowner; receive inputs corresponding to at least one of available features or functionalities at the home; receive inputs corresponding to information associated with one or more home improvement projects; determine a homeowner-personality type and a current level of the homeowner-personality type using at least some of the received inputs including (i) the at least one of the available features or functionalities at the home, and (ii) the one or more home improvement projects; generate a list of actions for the homeowner to take to move to one or more higher levels for the determined homeowner-personality type; and cause display of a second interface view of the frontend application for displaying at least one of the determined homeowner-personality type, the current level of the homeowner-personality type, and the list of actions to move to the one or more higher levels for determined homeowner-personality type.

An additional embodiment may include the computer system of above, wherein the at least one processor is further programmed to cause display of the first interface view of the frontend application by causing display of a plurality of graphical elements corresponding to each of the available features or functionalities, each graphical element of the plurality of graphical elements enabling the homeowner to select a respective available feature or functionality from the available features or functionalities.

An additional embodiment may include the computer system of above, wherein the at least one processor is further programmed to cause display of the first interface view of the frontend application by generating a list of home improvement projects based at least in part upon the available features or functionalities at the home of the homeowner.

An additional embodiment may include the computer system of above, wherein the at least one processor is further programmed to generate the list of actions for the homeowner by associating a respective level of homeowner-personality type corresponding to each action of the list of actions.

An additional embodiment may include the computer system of above, wherein the at least one processor is further programmed to identify a reward for the homeowner at least in part based upon the current level of the homeowner-personality type and the determined homeowner-personality type.

An additional embodiment may include the computer system of above, wherein the at least one processor is further programmed to: determine a grade or a ranking score associated with the home of the homeowner; and cause display of the grade or the ranking score associated with the home of the homeowner on a display of the user equipment of the homeowner.

An additional embodiment may include the computer system of above, wherein the at least one processor is further programmed to cause display, on a display of the user device of the homeowner, of a notification or an alert associated with an action to be taken by the homeowner.

An additional embodiment may include the computer system of above, wherein the at least one processor is further programmed to: cause display of one or more avatars associated with the determined homeowner-personality type for the homeowner to select from; and cause display of an avatar selected by the homeowner from the displayed one or more avatars.

Another exemplary embodiment may include a computer-implemented method implemented using a computing device in communication with a memory. The method may include: causing display of a first interface view of a frontend application executing on a user device of a user to receive inputs for generating a profile of a home of a homeowner and a profile of the homeowner; receiving inputs corresponding to at least one of available features or functionalities at the home; receiving inputs corresponding to information associated with one or more home improvement projects; determining a homeowner-personality type and a current level of the homeowner-personality type using at least some of the of the received inputs including (i) the at least one of available features or functionalities at the home, and (ii) the one or more home improvement projects; generating a list of actions for the homeowner to take to move to one or more higher levels for the determined homeowner-personality type; and causing display of a second interface view of the frontend application for displaying at least one of the determined homeowner-personality type, the current level of the homeowner-personality type, and the list of actions to move to the one or more higher levels for determined homeowner-personality type.

An additional embodiment may include the computer-implemented method of above, wherein causing display of the first interface view of the frontend application further comprises displaying a plurality of graphical elements corresponding to each of the available features or functionalities, each graphical element of the plurality of graphical elements enabling the homeowner to select a respective available feature or functionality from the available features or functionalities.

An additional embodiment may include the computer-implemented method of above, further comprising causing display of details corresponding to a feature or a functionality associated with a graphical element of the plurality of graphical elements upon detecting a presence of a user input control within a predetermined threshold distance of the graphical element displayed on a display of the user device of the user, wherein the details are displayed as an overlay over a current interface view of the frontend application.

An additional embodiment may include the computer-implemented method of above, wherein causing display of the first interface view of the frontend application further comprises generating a list of home improvement projects based at least in part upon the available features or functionalities at the home of the homeowner.

An additional embodiment may include the computer-implemented method of above, wherein generating the list of actions for the homeowner comprises associating a respective level of homeowner-personality type corresponding to each action of the list of actions.

An additional embodiment may include the computer-implemented method of above, further comprising identifying a reward for the homeowner at least in part based upon the current level of the homeowner-personality type and the determined homeowner-personality type.

An additional embodiment may include the computer-implemented method of above, further comprising: determining a grade or a ranking score associated with the home of the homeowner; and causing display of the grade or the ranking score associated with the home of the homeowner on a display of the user equipment of the user.

An additional embodiment may include the computer-implemented method of above, further comprising: determining a change in the grade or the ranking score associated with the home of the homeowner; and causing display of the change in the grade or the ranking score associated with the home of the homeowner on the display of the user equipment of the user.

An additional embodiment may include the computer-implemented method of above, further comprising causing display, on a display of the user device of the user, of a notification or an alert associated with an action to be taken by the homeowner.

An additional embodiment may include the computer-implemented method of above, further comprising: causing display of one or more avatars associated with the determined homeowner-personality type for the homeowner to select from; and causing display of an avatar selected by the homeowner from the displayed one or more avatars.

Another exemplary embodiment may include a non-transitory computer-readable storage media having computer-executable instructions embodied thereon. When executed by at least one processor, the computer-executable instructions cause the at least one processor to: cause display of a first interface view of a frontend application executing on a user device of a user to receive inputs for generating a profile of a home of a homeowner and a profile of the homeowner; receive inputs corresponding to at least one of available features or functionalities at the home; receive inputs corresponding to information associated with one or more home improvement projects; determine a homeowner-personality type and a current level of the homeowner-personality type using at least some of the of the received inputs including (i) the at least one of available features or functionalities at the home, and (ii) the one or more home improvement projects; generate a list of actions for the homeowner to take to move to one or more higher levels for the determined homeowner-personality type; and cause display of a second interface view of the frontend application for displaying at least one of the determined homeowner-personality type, the current level of the homeowner-personality type, and the list of actions to move to the one or more higher levels for determined homeowner-personality type.

An additional embodiment may include the computer-instructions of above, wherein the homeowner-personality type or the current level of the homeowner-personality type is determined based on a projected budget of the one or more home improvement projects.

### MACHINE LEARNING AND OTHER MATTERS

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, the one or more application servers 106a, 106b, and/or 106c of the smart system 100 is configured to implement machine learning, such that the one or more application server 106a-c “learn” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of home attributes with known characteristics or features. Such information may include, for example, information associated with a plurality of smart devices, features and/or functionalities of homes, skills of various homeowners, training and/or educational programs attended by homeowners, home improvement projects initiated and/or completed by the homeowners, and so on.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

In certain embodiments, home improvement projects and associated budgets, and/or a homeowner-personality type and/or current level of the homeowner-personality type may be identified or generated using machine learning techniques, including generative AI techniques and/or ChatGPT-based or other bots. For instance, smart home sensor data and data about the homeowner may be input into one or more trained machine learning models, including those discussed elsewhere herein, to generate or recommend home improvement projects and homeowner-personality types and levels. The smart home sensor data and data about the homeowner may generated or collected by one or more of the user devices mentioned herein or other input/output devices, such as mobile devices, VR headsets, AR glasses, voice or chat bots, wearables, home-mounted sensors and cameras, etc. The machine learning models may be trained to generate or recommend home improvement projects and homeowner-personality types and levels using historical data, such as historical smart home data and/or historical user data associated with a particular homeowner and/or other users/homeowners. Other data types may be used to train the machine learning model(s)/generative AI models, and other data types may be input to the models once trained to identify the outputs mentioned herein, such as home improvement projects, associated budgets, and homeowner-personality types. The other data types may include the data types mentioned elsewhere herein, as well as other data types.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system may be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system comprising:
at least one memory; and
at least one processor in communication with the at least one memory, wherein the at least one processor is programmed to:
cause display of a first interface view of a frontend application executing on a user device of a homeowner to receive inputs for generating a profile of a home of the homeowner and a profile of the homeowner;
receive inputs corresponding to at least one of available features or functionalities at the home;
receive inputs corresponding to information associated with one or more home improvement projects;
determine a homeowner-personality type and a current level of the homeowner-personality type using at least some of the received inputs including (i) the at least one of the available features or functionalities at the home, and (ii) the one or more home improvement projects;
generate a list of actions for the homeowner to take to move to one or more higher levels for the determined homeowner-personality type; and
cause display of a second interface view of the frontend application for displaying at least one of the determined homeowner-personality type, the current level of the homeowner-personality type, and the list of actions to move to the one or more higher levels for determined homeowner-personality type.

2. The computer system of claim 1, wherein the at least one processor is further programmed to cause display of the first interface view of the frontend application by causing display of a plurality of graphical elements corresponding to each of the available features or functionalities, each graphical element of the plurality of graphical elements enabling the homeowner to select a respective available feature or functionality from the available features or functionalities.

3. The computer system of claim 2, wherein the at least one processor is further programmed to cause display of the first interface view of the frontend application by generating a list of home improvement projects based at least in part upon the available features or functionalities at the home of the homeowner.

4. The computer system of claim 1, wherein the at least one processor is further programmed to generate the list of actions for the homeowner by associating a respective level of homeowner-personality type corresponding to each action of the list of actions.

5. The computer system of claim 1, wherein the at least one processor is further programmed to identify a reward for the homeowner at least in part based upon the current level of the homeowner-personality type and the determined homeowner-personality type.

6. The computer system of claim 1, wherein the at least one processor is further programmed to:
determine a grade or a ranking score associated with the home of the homeowner; and
cause display of the grade or the ranking score associated with the home of the homeowner on a display of the user equipment of the homeowner.

7. The computer system of claim 1, wherein the at least one processor is further programmed to cause display, on a display of the user device of the homeowner, of a notification or an alert associated with an action to be taken by the homeowner.

8. The computer system of claim 1, wherein the at least one processor is further programmed to:
cause display of one or more avatars associated with the determined homeowner-personality type for the homeowner to select from; and
cause display of an avatar selected by the homeowner from the displayed one or more avatars.

9. A computer-implemented method implemented using a computing device in communication with a memory, the method comprising:
causing display of a first interface view of a frontend application executing on a user device of a user to receive inputs for generating a profile of a home of a homeowner and a profile of the homeowner;
receiving inputs corresponding to at least one of available features or functionalities at the home;
receiving inputs corresponding to information associated with one or more home improvement projects;
determining a homeowner-personality type and a current level of the homeowner-personality type using at least some of the of the received inputs including (i) the at least one of available features or functionalities at the home, and (ii) the one or more home improvement projects;
generating a list of actions for the homeowner to take to move to one or more higher levels for the determined homeowner-personality type; and
causing display of a second interface view of the frontend application for displaying at least one of the determined homeowner-personality type, the current level of the homeowner-personality type, and the list of actions to move to the one or more higher levels for determined homeowner-personality type.

10. The computer-implemented method of claim 9, wherein causing display of the first interface view of the frontend application further comprises displaying a plurality of graphical elements corresponding to each of the available features or functionalities, each graphical element of the plurality of graphical elements enabling the homeowner to select a respective available feature or functionality from the available features or functionalities.

11. The computer-implemented method of claim 10, further comprising causing display of details corresponding to a feature or a functionality associated with a graphical element of the plurality of graphical elements upon detecting a presence of a user input control within a predetermined threshold distance of the graphical element displayed on a display of the user device of the user, wherein the details are displayed as an overlay over a current interface view of the frontend application.

12. The computer-implemented method of claim 10, wherein causing display of the first interface view of the frontend application further comprises generating a list of home improvement projects based at least in part upon the available features or functionalities at the home of the homeowner.

13. The computer-implemented method of claim 9, wherein generating the list of actions for the homeowner comprises associating a respective level of homeowner-personality type corresponding to each action of the list of actions.

14. The computer-implemented method of claim 9, further comprising identifying a reward for the homeowner at least in part based upon the current level of the homeowner-personality type and the determined homeowner-personality type.

15. The computer-implemented method of claim 9, further comprising:
determining a grade or a ranking score associated with the home of the homeowner; and
causing display of the grade or the ranking score associated with the home of the homeowner on a display of the user equipment of the user.

16. The computer-implemented method of claim 15, further comprising:
determining a change in the grade or the ranking score associated with the home of the homeowner; and
causing display of the change in the grade or the ranking score associated with the home of the homeowner on the display of the user equipment of the user.

17. The computer-implemented method of claim 9, further comprising causing display, on a display of the user device of the user, of a notification or an alert associated with an action to be taken by the homeowner.

18. The computer-implemented method of claim 9, further comprising:
causing display of one or more avatars associated with the determined homeowner-personality type for the homeowner to select from; and
causing display of an avatar selected by the homeowner from the displayed one or more avatars.

19. A non-transitory computer-readable storage media having computer-executable instructions embodied thereon, wherein when executed by at least one processor, the computer-executable instructions cause the at least one processor to:
cause display of a first interface view of a frontend application executing on a user device of a user to receive inputs for generating a profile of a home of a homeowner and a profile of the homeowner;
receive inputs corresponding to at least one of available features or functionalities at the home;
receive inputs corresponding to information associated with one or more home improvement projects;
determine a homeowner-personality type and a current level of the homeowner-personality type using at least some of the of the received inputs including (i) the at least one of available features or functionalities at the home, and (ii) the one or more home improvement projects;
generate a list of actions for the homeowner to take to move to one or more higher levels for the determined homeowner-personality type; and
cause display of a second interface view of the frontend application for displaying at least one of the determined homeowner-personality type, the current level of the homeowner-personality type, and the list of actions to move to the one or more higher levels for determined homeowner-personality type.

20. The non-transitory computer-readable storage media of claim 19, wherein the homeowner-personality type or the current level of the homeowner-personality type is determined based on a projected budget of the one or more home improvement projects.
